(19) United States
(12) Patent Application Publication
(10) Pub. No.: US 2016/0165313 A1
(43) Pub. Date: Jun. 9, 2016

(54) ELECTRONIC PROGRAMMING GUIDE GENERATION

(71) Applicant: EchoStar Technologies L.L.C., Englewood, CO (US)

(72) Inventor: Carlos Garcia Navarro, Boulder, CO (US)

(73) Assignee: EchoStar Technologies LLC

(21) Appl. No.: 14/564,202

(22) Filed: Dec. 9, 2014

(51) Int. Cl. H04N 21/482

(52) U.S. Cl. CPC H04N 21/482

(57) ABSTRACT

A computing device is programmed to receive a popular channel database from a remote server and store the popular channel database in the memory. The popular channel database includes data representing the number of subscribers viewing the respective channels offered by a service provider at one or more viewing times. The processor generates an electronic programming guide which displays the channels ordered at least in part based on popularity of the respective channels as determined from the data in the popular channel database.

### BACKGROUND

A computing device such as a set top box or the like, generally stores a list of channels to which a subscriber has access, and displays those in an Electronic Program Guide (EPG). Typically these channels are ordered by channel ID, that is, according to the order they have been assigned in the EPG. The number of available channels is often large. Searching through a long list of channels can be unduly time consuming, and/or can result in a user overlooking a program of interest.

### DRAWINGS

FIG. 1 is a block diagram of an exemplary system for generating an electronic programming guide based on channel popularity.

FIG. 2 is a block diagram of an exemplary remote server for the system of FIG. 1.

FIG. 3 is a block diagram of an exemplary computing device for the system of FIG. 1.

FIG. 4 illustrates an exemplary display for displaying an electronic programming guide by a computing device.

FIG. 5 is a diagram of an exemplary process for generating an ordered channel list based on channel popularity.

FIG. 6 is a diagram of an exemplary process for generating and displaying an electronic programming guide including the ordered channel list of FIG. 5.

### DETAILED DESCRIPTION

### Overview

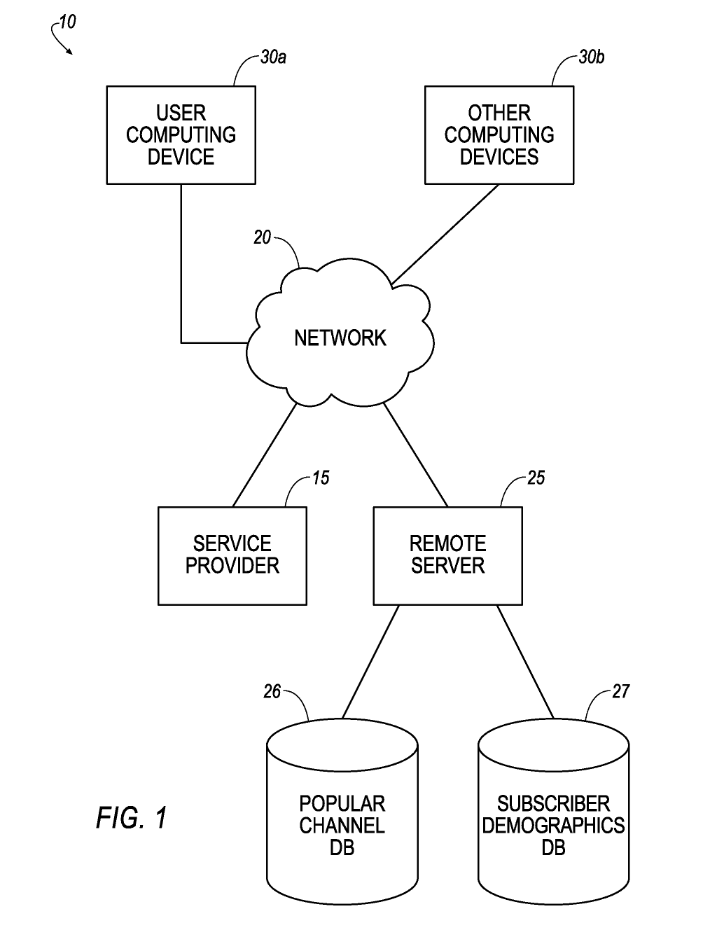

FIG. 1 is a block diagram of an exemplary system 10 for generating an electronic programming guide 12 based on channel popularity data and providing the electronic programming guide to subscribers of a programming service such as satellite or cable television. The system 10 includes a service provider 15, e.g., a satellite or cable television head end that provides programming for subscribers. A network 20 connects the service provider 15 to a remote server 25, a computing device 30a and/or other computing devices 30b. The remote server 25 collects data regarding viewing behavior of subscribers, e.g., a first subscriber associated with the computing device 30a and other subscribers associated with other computing devices 30b, with respect to programming services of the service provider 15. The server 25 further generates a popular channel database 26 from this data. The remote server 25 further provides access to the popular channel database 26 to subscribers via the network 20. The remote server 25 may further generate and provide access to a subscriber demographics database 27 containing demographic information regarding the subscribers.

For example, the computing device 30a may download the popular channel database 26 from the remote server 25. Upon receiving the popular channel database 26, the computing device 30a generates the electronic programming guide 12 for the first subscriber (hereinafter the user) based in part on the popular channel database 26. As an example, the computing device 30a may generate an ordered channel list, the list being ordered according to a number of subscribers respectively viewing each channel at a specified viewing time. The viewing time may be chosen to be proximate, e.g., within 5 minutes of, a current time when the user is selecting a program. That is, the ordered list could reflect the number of subscribers viewing each of the available channels at the current time. For example, the currently most viewed channel could appear first in the list, followed by the second most viewed channel, etc. Accordingly, the user can quickly and easily identify popular programs that the user might otherwise overlook.

As another example, the remote device 25 may also provide the subscriber demographics database 27 to the computing device 30a. Based on the popular channel database 26, and the subscriber demographics database 27, the computing device 30a could generate the ordered channel list based on the popularity of channels amongst subscribers with demographic data similar to the demographic data of the user. Such programming may be more likely to be of interest to the user.

### Exemplary System Elements

As stated above, the system 10 includes a service provider 15. The service provider 15 may include one or more computer servers (some or all of which may be referred to as “media servers”) and data storage devices, e.g., for storing and processing programming and other data such as discussed herein. Elements of the service provider 15 may be local to one another and/or may be distributed amongst multiple locations.

The service provider 15 generally provides multiple channels of television programming. Alternatively or additionally, the service provider 15 may provide, for example, video-on-demand, music services, etc. The service provider 15 may provide to a user hundreds (or more) available programs from which to choose. The service provider 15 provides this programming through, for example, satellite communications, an installed cable network, the internet as internet protocol television (IPTV), etc. The programming is accessed by the user computing device 30a and the other computing devices 30b (collectively computing devices 30) via the network 20. In general, examples of programming content include various types of data, including audio, video, images, etc.

Programming is generally delivered via the network 20 in a digital format, e.g., as compressed audio and/or video data. The programming generally includes, according to such digital format, media data and media metadata. For example, MPEG refers to a set of standards generally promulgated by the International Standards Organization/International Electrical Commission Moving Picture Experts Group (MPEG). H.264 refers to a standard promulgated by the International Telecommunications Union (ITU). Accordingly, by way of example and not limitation, programming may be provided in a format such as the MPEG-1, MPEG-2 or the H.264/MPEG-4 Advanced Video Coding standards (AVC) (H.264 and MPEG-4 at present being consistent), or according to some other standard or standards. For example, programming could be audio data formatted according to standards such as MPEG-2 Audio Layer III (MP3), Advanced Audio Coding (AAC), etc.

Programming generally includes media content as it is usually provided for general distribution, e.g., a movie, television program, video file, audio file, etc. in a form has provided by a distributor of the media content. Alternatively or additionally, the media content may be modified from the form provided by a general distributor of content (e.g., recompressed, re-encoded, etc.). The media data includes data by which a display, playback, representation, etc. of the media content is presented on a computing device 30. For example, media data generally includes units of encoded and/or compressed video data, e.g., frames of an MPEG file or stream.

Communications to and from the service provider 15, remote server 25, and computing devices 30 generally occur via the network 20. In general, the network 20 represents one or more mechanisms for transferring data between the elements connected to the network 20. For example, the network 20 may provide one or more mechanisms for delivering programming from the service provider 15 to computing devices 30. Further, the network 20 may provide one or more mechanisms for exchanging data between the remote server and the computing devices 30. Accordingly, the network 20 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include satellite or cable television communications, wireless communication networks, local area networks (LAN) and/or wide area networks (WAN), including the Internet, etc.

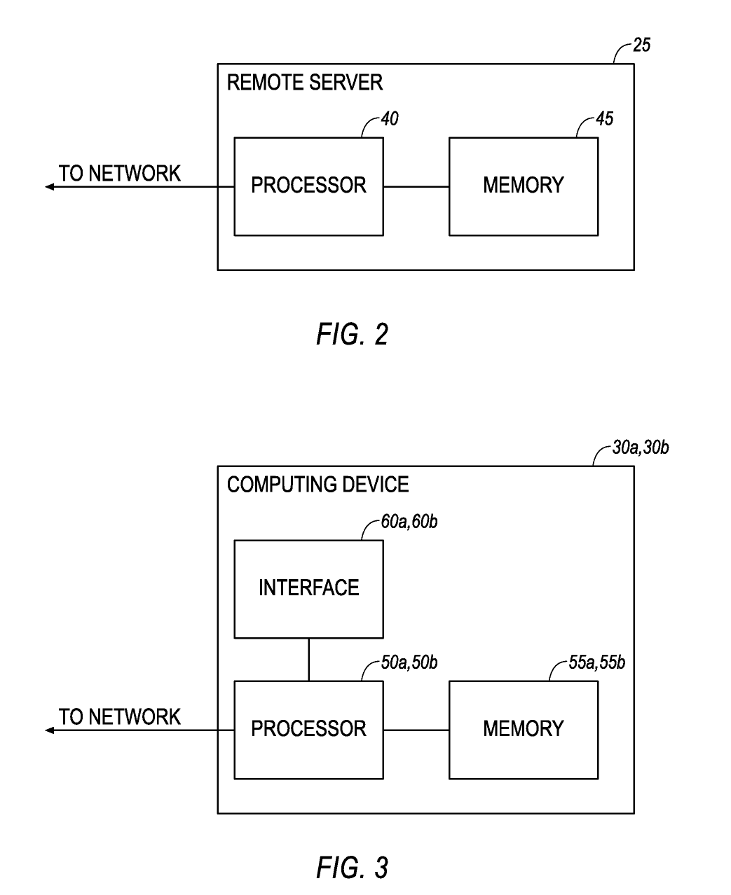

As shown in FIG. 2, the remote server 25 generally includes a server processor 45 and a server memory 50 communicatively coupled to the server processor 45. The server memory 50 may include one or more forms of computer-readable media, and may store instructions executable by the server processor 45 for performing various operations, including as disclosed herein. Further, the remote server may include and/or be communicatively coupled to one or more other computing devices. The remote server is generally configured for communications on the network 20.

In an exemplary system 10, the remote server 25 monitors viewing behavior of subscribers of programming offered by the service provider 15, and may collect other data associated with the subscribers. The term subscribers, as used herein, includes users, sometimes also called viewers, who have access to all or a portion of the programming offered by the service provider 15, and includes a user associated with computing device 30a, and other users associated with other computing devices 30b. The subscriber viewing behavior refers at least to an identification of an item of media content, such as a television program, on demand video or audio, a streaming video or audio etc., that a subscribers views, along with a time or times at which the subscriber viewed the item of media content. The remote server 25 accesses viewing behavior, and where applicable, demographic data of the subscribers, e.g., the popular channel database 26 and subscriber demographics database 27.

In order to monitor viewing behavior of the subscribers, the remote server 25 may, for example, receive a message from a computing device 30 associated with a subscriber indicating that the computing device 30 is receiving a program. The message may include identification of the remote device 30 sending the message, identification of the program being received by the computing device 30, a start-to-view time when the remote device 30 started to receive the program, etc. Alternatively, the remote server 25 may receive messages from the service provider 15 providing data regarding which remote devices 30 are respectively receiving the programs being provided by the service provider 15 at a viewing time.

Based on the messages that the remote server 25 receives from the computing devices 30 and/or the service provider 15, the remote server 25 updates the popular channel database 26. The popular channel database 26 may be stored in the remote server 25 memory, or in another memory communicatively coupled with the remote server 25.

The popular channel database 26 generally contains information about the popularity of the programs being offered by the service provider, based on the viewing behavior of subscribers. One example of an organization for the popular channel database 26 is shown in Table 1.

TABLE 1

| Channel ID | # of Viewers |
|---|---|
| Channel 1 | 1,000,023 |
| Channel 2 | 400,001 |
| Channel 3 | 743,015 |
| Channel 4 | 121 |
| Channel N | 23,008 |

In this example, the popular channel database 26 provides a number of subscribers viewing respective channels of the service provider 15 at a last viewing time. For example, the remote server 25 could receive messages from the computing devices 30 and/or the service provider 15 on an interrupt basis, i.e., based on a timing determined by the computing device 30 or service provider 15 sending the message. The remote server 25 could accumulate the messages. On a periodic basis, for example once per minute, the remote server 25 may update the popular channel database 26 to reflect the current number of viewers viewing each channel, based on the previous data from the database, and the messages received since the last update. Although Table 1 shows only five channels, the popular channel database 26 could include any number of channels, and likely includes hundreds of channels, if not more.

The number of viewers for a channel may be determined according to a number of computing devices 30 receiving the respective channel at a viewing time. Additional criteria could also be considered. For example, the remote server 25 may only include those computing devices 30 that have been receiving a channel for a predetermined period of time, for example, 3 minutes, in the number of viewers for the channel. This would reduce the influence of “channel surfing” on the data reflected in the popular channel database 26.

As another example, the popular channel database 26 could include data regarding the number of viewers of respective channels at multiple viewing times. This is shown in Table 2.

TABLE 2

| Channel ID | # of viewers at t1 | # of viewers at t2 | # of viewers at t3 |
|---|---|---|---|
| Channel 1 | 1,000,023 | 300,412 | 1,543,012 |
| Channel 2 | 400,001 | 563,444 | 204,379 |
| Channel 3 | 743,015 | 1,101,000 | 642,978 |
| Channel 4 | 121 | 549 | 1,012 |
| Channel N | 23,008 | 46,752 | 14,589 |

In this example, t1 could be, for example the viewing time corresponding to the most recent update of the popular channel database 26. The time t2 could be a viewing time 30 minutes prior to t1, and t3 could be a viewing time 30 minutes prior to t2. Alternatively, t1 could be the viewing time corresponding to the most recent update, and each of the times t2 and t3 could be earlier viewing times corresponding to times of day when programming typically changes. For example, if t1 was 9:14 pm, t2 could be 9:00 pm and t3 could be 8:30 pm. Viewer data regarding any number of viewing times may be included in the popular channel database 26.

In addition to maintaining the popular channel database 26, the remote server 25 may maintain a subscriber demographics database 27. The remote server 25, may receive, for example, data regarding the occupation, age, marital status, country of origin, ethnicity, etc. of a subscriber associated respectively with one or more of the computing devices 30. The remote server 25 may store the subscriber demographic data in the subscriber demographic database.

For example, the subscriber demographic database may be organized as shown in Table 3.

TABLE 3

| Subscriber | | Marital | | Country | |
|---|---|---|---|---|---|
| ID | Occupation | Status | Age | of Origin | Ethnicity |
| 001 | Lawyer | Married | 30-34 | USA | Caucasian |
| 002 | Engineer | Single | 30-34 | Spain | Hispanic |
| 003 | Engineer | Married | 30-34 | Spain | Asian |
| 004 | Teacher | Married | 50-54 | USA | African- |
| | | | | | American |
| 005 | Teacher | Single | 25-29 | France | Caucasian |

The subscriber demographic database may be provided to the computing devices 30, and used to correlate viewers of programming with, for example, the user of the computing device 30a currently selecting a channel. Exemplary computing devices 30 include a set top box, a personal computer such as a laptop, handheld, or tablet computer, a smart phone, etc.

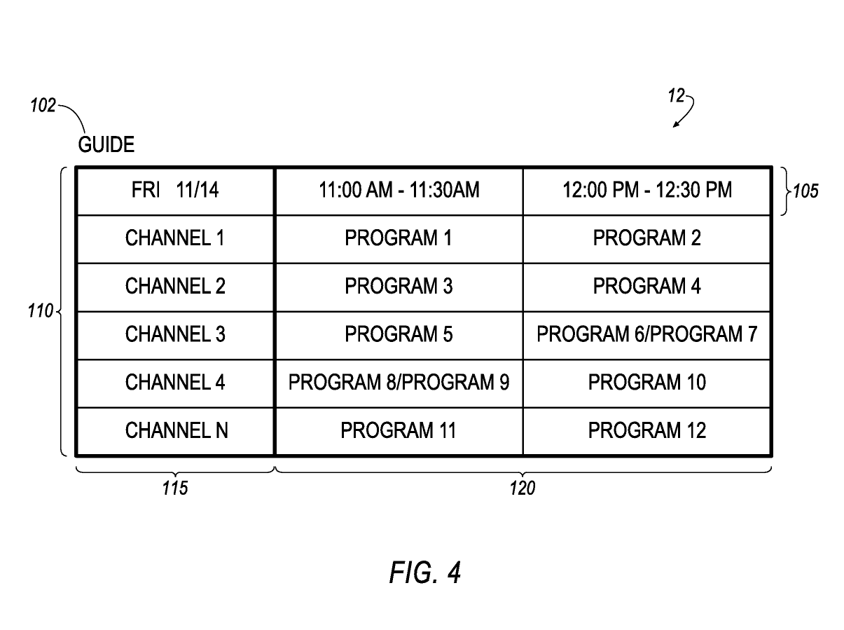

As shown in FIG. 3, each of the computing devices 30a, 30b includes respectively a processor 50a, 50b. Each processor 50a, 50b is communicatively coupled to a respective memory 55a, 55b and a respective interface 60a, 60b. Each computing device memory 55a, 55b may include one or more forms of computer-readable media, and may store instructions executable by the respective computing device processor 50a, 50b for performing various operations, including as disclosed herein. Further, each of the computing devices 30a, 30b may include and/or be communicatively coupled to one or more other computing devices.

For purposes of example, the operation of computing device 30a will be described below. It is understood that the other computing devices 30b operate in a similar manner.

The computing device 30a includes a processor 50a. Generally, the processor 50a is programmed to communicate with the other devices connected to the network 20, e.g., the service provider 15, the remote server 25, the other computing devices 30b, etc. The processor 50a is further programmed communicate with the memory 55a and interface 60a of the computing device 30a. As described further below the processor 50a generates the electronic programming guide 12 and outputs the electronic programming guide 12 to the interface 60a.

The interface 60a may include a variety of known mechanisms for allowing a user to interface with the computing device 30a. For example, the interface 60a could include an output to a television or other display for presenting programming of the service provider 15 to the subscriber via an external device. The interface 60a may further include a microphone, a speaker, text to speech, speech recognition processing capability, etc., for allowing verbal and/or audio interaction with the computing device 30, e.g., in the form of an interactive voice response (IVR) system such as is known. Further, the interface 60a could include a visual display, touchscreen or the like, and/or other input/output mechanisms.

The interface 60a provides graphical user interfaces (GUIs) to the user for interfacing with the computing device 30a. An example of a GUI provided by the interface 60a is the electronic programming guide 12. The electronic programming guide 12, as is known, allows the user to select programming to be viewed via the computing device 30a. That is, the electronic programming guide 12 provides information to the user regarding the availability of programming on different channels at different times, allows the user to scroll through the available programming and select a program for viewing. The electronic programming guide 12 may also offer other capabilities, such as selecting a program for recording at a future time, selecting a recorded program for viewing, selecting a video on demand for immediate viewing, etc.

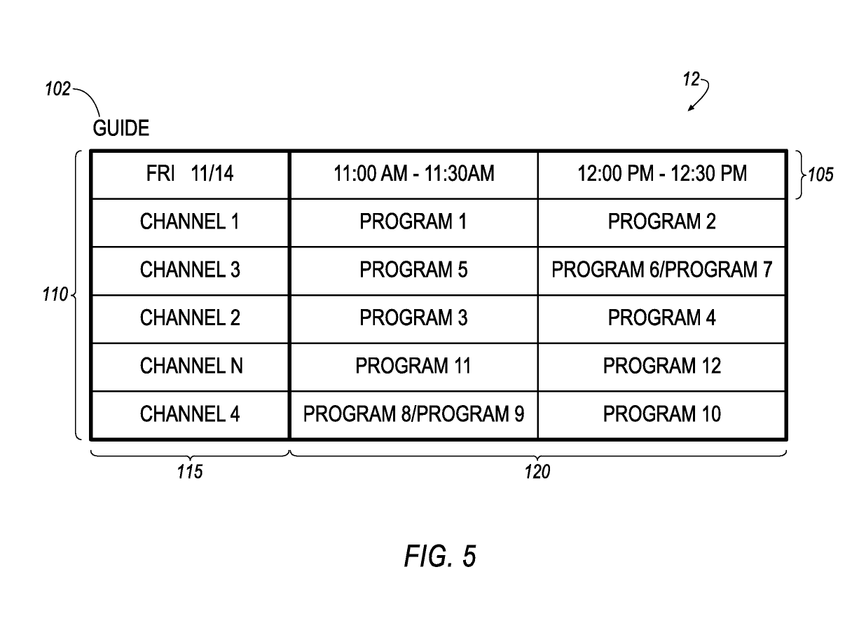

As shown in FIG. 4, the electronic programming guide 12 includes a title field 102, a date and time field 105, a guide area 110, a channel field 115 and a program description area 120.

The title field 102 identifies a graphical user interface being displayed. In the case of the electronic programming guide, the title could be “Guide”, or the like.

The date and time field 105 indicates the date and time that the programs on the channels provided by the service provider 15 are available for viewing. The date and time field 105 typically appears above the guide area 110.

The guide area 110 includes the date and time field 105, the channel list field 115, as well as the program description area 120. The guide area 110 indicates which programs are available on the channels provided by the service provider 15, and further indicates at what time the programs are available on those channels.

The channel list field 115 provides an ordered list of channels available from the service provider 15. As illustrated in FIG. 4, the channels may be ordered according to channel ID. That is, channel 1 may be first on the ordered list, channel 2 may be second, etc. Other arrangements are possible. The ordered list may include all channels provided by the service provider 15, or only those channels that are available to the user, i.e., to which the user subscribed. As described in detail below, the channel list may be ordered according to the popularity of the programs on the channels at viewing times.

The program description area 120 displays the programs available on the channels listed in the channel list field 115. As shown in FIG. 4, the program description area 120 may be a two-dimensional matrix with rows corresponding to each of the channels displayed in the channel list field 115. The rows may extend horizontally across the program description area 120 and display one or more programs, the location of the programs in the rows corresponding to times displayed above the program description area 120 in the time and date field 105.

For example, as shown in FIG. 4, a “Program 2” is displayed in a row corresponding to “Channel 1” and at a location indicating that the “Program 2” starts at 12 PM and continues until 1 PM.

The processor 50a is programmed to provide the electronic program guide 12 to the user, support selection by the user of channels available from the service provider 15, receive the channels from the service provider 15 and output the channels to the interface 60a.

The processor 50a is further typically programmed to generate an ordered list of channels for the electronic programming guide 12 based on the popular channel database 26. The processor 50a is programmed to receive the popular channel database 26 from the remote server 25, for example, by downloading. The processor 50a may initiate a first download when the computing device 30a is activated. Thereafter, the processor 50a may download an updated popular channel database 26 on a periodic basis, for example once every minute or once every five minutes, etc.

Based on the popular channel database 26, the processor 50a generates an ordered list of channels. The popular channel database 26 may include the number of viewers viewing each channel at a viewing time. Table 1 above is an example of such a popular channel database 26. The ordered list may list the channel with the largest number of viewers first, the channel with the second largest number of viewers second, etc. In the case of the popular channel database 26 of Table 1, the ordered list may appear as shown in Table 4 below.

TABLE 4

Channel 1
Channel 3
Channel 2
Channel N
Channel 4

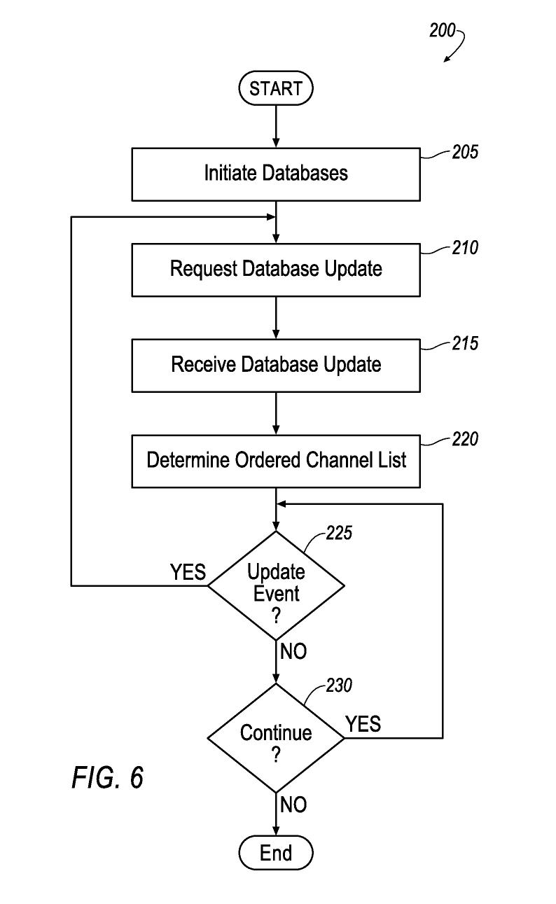

Based on the ordered channel list organized according to the data in the popular channel database 26, the processor 50a may generate the electronic programming guide 12. As shown in FIG. 5, the electronic programming guide 12 may include the ordered channel list of Table 4 in the channel list field 115.

The processor 50a may further be programmed to generate the ordered list of channels based on the average number of viewers viewing each channel over a number of viewing times. According to this example, the popular channel database 26 may include the number of viewers viewing each channel at a plurality of viewing times. Table 2 above is an example of data from such a popular channel database 26. The processor 50a may, according to input from the user, select multiple viewing times associated with each channel, and determine an average. The processor 50a may then generate an ordered list of channels listing the channel with the largest average number of viewers first, the channel with the second largest average number of viewers second, etc.

The viewing times selected for determining the average may be consecutive times, for example, all the viewing times between 6 PM and 9 PM on a current day. Alternatively, the selected viewing times may be nonconsecutive. For example, the processor 50a may determine an average based on the number of viewers of each channel at 7 PM on each of the preceding four Tuesdays. The processor 50a may provide a calendar type interface to the user to select the viewing times to be used for determining the average number of viewers of each channel.

In addition to a number of subscribers viewing channels at particular viewing times, the processor 50a may consider demographic information regarding subscribers viewing particular channels at particular times.

As described above, the remote server 25 may generate and maintain the subscriber demographics database 27. Each subscriber could have a subscriber ID. The subscriber demographics database 27 could include demographic data related to each of the subscribers such as profession, age, marital status, etc. An example of the subscriber demographics database 27 is shown in Table 3 above. The remote server 25 could provide the subscriber demographics database 27 to the computing device 30a.

Based on the subscriber demographics database 27, the processor 50a could determine a correlation factor between each of the subscribers, and, for example, the user of 30a.

The user may have the following demographic data.

TABLE 5

| Subscriber | | Marital | | Country | |
|---|---|---|---|---|---|
| ID | Occupation | Status | Age | of Origin | Ethnicity |
| 006 | Engineer | Married | 30-34 | USA | Asian |

The processor 50a may compare one or more demographic characteristics of a user, e.g., subscriber ID 006 with one or more other subscribers. The processor 50a may assign a compatibility value of 1 for each demographic characteristic that matches, and a compatibility value of 0 for each characteristic that does not match. As an example, in comparing the demographic characteristics of the user (ID 006) with the subscriber 001, the processor 50a may generate the following Table 6.

TABLE 6
Correlation of Subscriber 006 to Subscriber 001

| Category | Compatibility |
|---|---|
| Occupation | 0 |
| Marital Status | 1 |
| Age | 1 |
| Country of Origin | 1 |
| Ethnicity | 0 |

Based on the comparison, the processor 50a can determine that 3 out of 5 characteristics are compatible and assign a correlation value of ⅗ or 60%. In this manner, the processor 50a can develop a correlation value of various subscribers to one another.

Based on the correlation values, and the popular channel database 26, the processor 50a could develop an ordered channel list that represents the popularity of each channel to subscribers compatible to the user.

For example, the processor 50a may determine that all subscribers with a correlation value greater than 50% with respect to a particular user are compatible to the user. Further, the popular channel database 26 may provide the subscriber ID of each of the subscribers viewing each of the channels. The processor 50a may adjust the number of subscribers viewing each channel to reflect only those subscribers with a correlation value of greater than 50%. The processor 50a may then generate an ordered list of channels based on the adjusted viewer numbers. According to this method, the first channel in the list would be the channel with the largest number of viewers that have a correlation value of greater than 50% with respect to the user.

The processor 50a may be programmed to generate the ordered channel list in many ways. The exemplary mechanisms above may be combined. For example, the processor 50a could receive a popular channel database 26 including the subscriber ID of each subscriber viewing each channel at multiple viewing times. The processor 50a could adjust each of the numbers of viewers to reflect the correlation of the viewers to the user. Based on these adjusted numbers, the processor 50a could determine an average number of viewers of each channel over multiple viewer times. Based on these averages, the processor 50a could generate the ordered channel list.

Additionally, other data related to the user could be used in generating the ordered channel list. For example, the processor 50a could include only channels to which the user has subscribed in the ordered channel list. The processor 50a could also consider favorite user channels in generating the ordered channel list. Upon generating the ordered channel list, the processor 50a may store the ordered channel list in the memory 55a.

Based on the ordered channel list, the processor 50a generates the electronic programming guide 12. Generating the electronic programming guide 12 may be initiated, for example, by a request from the user via the interface 60a. The processor 50a inserts the ordered channel list in the channel field 115. The processor 50a inserts the programming associated with each of the channels in the program description area 120. The processor 50a then outputs the electronic programming guide 12 to the interface 60a.

Each of the other computing devices 30b may, similar to computing device 30a, includes a processor 50b, a memory 55b, and an interface 60b. The processor 50b of each of the other computing devices 30b may be programmed in a manner similar to the processor 50a of computing device 30a. Each of the computing devices 30b may provide an electronic programming guide 12 reflecting popularity data of channels as described above with regard to computing device 30a.

### Exemplary Process Flows

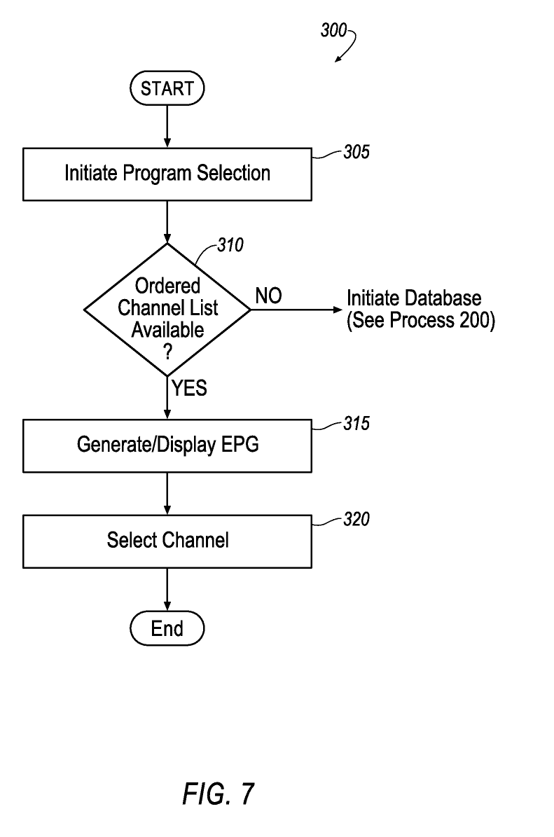

FIG. 6 is a diagram of an exemplary process 200 for generating an ordered channel list based on the popularity of programming channels at a viewing time.

The process begins in a block 205 in which the computing device 30a when an initiating event occurs, e.g., the computing device 30a is activated, rebooted, receives an input from the user, etc. The processor 50a of the computing device 30a recognizes that the initiating event has occurred, and proceeds to a block 210.

In the block 210, the processor 50a of the computing device 30a downloads the popular channel database 26, and, if applicable, the subscriber demographics database 27, from the remote server 25. For example, the processor 50a sends a message to the remote server 25 via the network 20 requesting the popular channel database 26, and, if applicable, the subscriber demographics database 27. The remote server 25 responds to the request and sends the popular channel database 26, and, if applicable, the subscriber demographics database 27, to the computing device 30a. The process 200 continues in a block 215.

In the block 215, the computing device 30a receives the popular channel database 26 and, if applicable, the subscriber demographics database 27, and stores each of the databases 26, 27 in the memory 55a. The process 200 then continues in a block 220.

In the block 220, the computing device 30a determines an ordered channel list based on the popular channel database 26 and, if applicable, the subscriber demographics database 27 received from the remote server 25. The ordered channel list may be determined according to the examples described above with regard to the computing device 30a. The order channel list may be determined based on the number of viewers of a channel at a viewing time, an average number of viewers over selected viewing times, etc.

Further, as described in detail with regard to the computing device 30a, the ordered channel list may be generated based on both of the popular channel database 26 and the subscriber demographics database 27. A list of subscribers viewing each channel may include subscriber IDs. The subscriber demographic database may include demographic characteristics of the subscribers. The processor 50a may compare the demographic characteristics of subscribers to the demographic characteristics of the user of the computing device 30a and determine which subscribers are compatible with the user. Based on the comparison, the processor 50a may adjust the number of subscribers viewing each channel to include only subscribers determined to be compatible with the user. Based on the adjusted numbers, the processor 50a may generate an ordered channel list according to the popularity of the channels at a viewing time.

As described above, other mechanisms may be used to generate the ordered channel list. Upon generating the order channel list, the processor 50a stores the list in the memory 55a. The process 200 then continues in a block 225.

In the block 225, the processor 50a determines whether an event has occurred that triggers downloading an updated popular channel database 26 and/or subscriber demographics database 27. For example, the processor 50a may be programmed to download an updated popular channel database 26 every 5 minutes while the computing device 30a is activated. Alternatively, or additionally, the processor 50a may be programmed to download an updated popular channel database 26 at times when programming typically changes, for example, on the hour and half hour. Further, the triggering event may be the receipt of a message from the remote server 25 that an updated popular channel database 26 and/or subscriber demographic database is available for downloading. Since the subscriber demographic database will change less often, a triggering event for downloading the subscriber demographic database could be a particular day of each month, for example the fifth day of each month. If the processor 50a determines that a triggering event has occurred, the process 200 continues in the block 210. If no triggering event is identified, the process 200 continues in a block 230.

In the block 230, the processor 50a determines if the process 200 should continue, or terminate. For example, if the user has turned off the computing device 30a, the processor 50a could discontinue the process 200 as part of a shutdown process. If the computing device 30a remains active, for example the user has selected, and is viewing a channel via the computing device 30a, the process 200 continues in the block 225.

FIG. 7 is a diagram of an exemplary process 300 for generating an electronic programming guide 12 based on an ordered channel list.

The process begins in a block 305, in which an initiating event is identified. For example, the user, through the interface 60a, requests the electronic programming guide 12 by depressing the guide button on a remote device in communication with the interface 60a. The processor 50a receives a signal from the interface 60a initiating the generation and display of the electronic programming guide 12. The process 300 continues in a block 310.

In the block 310, the processor 50a determines if an updated ordered channel list is available. For example, the processor 50a may determine whether the process 200 has updated the ordered channel list within the last 5 minutes, or since the most recent time when programming typically changes (e.g., every hour or half hour). If the ordered channel list has been updated, the process 300 continues in a block 315. If the ordered channel list has not been updated, the processor 50a may initiate the process 200, and continue to monitor for the generation of an updated ordered channel list.

In the block 315, the processor 50a generates the electronic programming guide 12 with the channels listing according to channel popularity, as described above. The processor 50a inserts the ordered channel list, generated by the process 200, into the channel field 115. The processor 50a further inserts the programming associated with the channels in the program description area 120. The processor 50a then displays the electronic programming guide 12 to the user via the interface 60a. The process 300 then continues in a block 320.

In the block 320, the user may use the electronic programming guide 12 to select a channel. The user may, for example, use the remote device in communication with the interface 60a to scroll through the ordered channel list, and identify a channel that the user would like to view. When the user, for example, selects the channel to view, chooses to turn off the electronic programming guide 12, or discontinues using the electronic programming guide 12 in some other manner, the process 300 ends.

### CONCLUSION

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A computing device comprising:
a processor and a memory storing program instructions executable by the processor; wherein the computing device is programmed to:
receive a popular channel database from a remote server and store the popular channel database in a memory of the computing device, wherein the popular channel database includes data indicating subscribers receiving media content respectively from each of one or more available channels at one or more viewing times;
receive a subscriber demographic database indicating a plurality of demographic characteristics of each subscriber;
for each of the one or more channels at the one or more viewing times, identify one or more demographic characteristics for each of a plurality of viewing subscribers;
determine a match score for each viewing subscriber that is a percentage of identified characteristics of the viewing subscriber receiving the media content from one of the one or more available channels at one of the one or more viewing times that match corresponding characteristics of a user of the computing device;
determine an order of one or more available channels to be listed in an electronic programming guide based at least in part on the number of subscribers receiving media content respectively from each of the one or more available channels at at least one of the one or more viewing times having a match score above a predetermined threshold;
and
display the electronic programming guide, including the one or more available channels in the determined order.

2. The computing device of claim 1, further programmed to:
recognize a start time when a user activates the computing device; and
download the popular channel database from the remote server upon recognizing the start time.

3. The computing device of claim 2, further programmed to determine the order of channels listed in the electronic programming guide based on the data representing the number of subscribers receiving media data respectively from each of the one or more available channels at a viewing time having a match score above the predetermined threshold within a predetermined period of the start time.

4. The computing device of claim 1, further is programmed to:
determine an average number of subscribers receiving respectively the one or more available channels over a plurality of viewing times having a match score above the predetermined threshold; and
determine an order of channels listed in the electronic programming guide based on the determined average number of subscribers receiving respectively the one or more channels.

5. The computing device of claim 1, further programmed to periodically download the popular channel database.

6. (canceled)

7. (canceled)

8. The computing device of claim 1, wherein the processor is further programmed to: receive user input data; and
determine the order of channels listed on the electronic programming guide based on the user input data, the popular channel database, and the subscriber demographic database.

9. The computing device of claim 8 wherein the user input data includes favorite channels identified by the user.

10. A system comprising:
a remote server comprising:
a processor; and
a memory;
wherein the server is programmed to:
collect subscriber data regarding subscribers receiving respectively each of one or more program channels, the subscriber data indicating subscribers receiving respectively each of the one more program channels at one or more viewing times;
store the subscriber data in a popular channel database;
collect demographic data regarding the subscribers, the demographic data indicating a plurality of demographic characteristics of each subscriber;
store the demographic data in a subscriber demographic database; and
provide the popular channel database and the subscriber demographic database to a remote computing device; and
the remote computing device programmed to:
receive the popular channel database and the subscriber demographic database from the remote server;
for each of the one or more program channels at the one or more viewing times, identify one or more demographic characteristics for each of a plurality of viewing subscribers;
determine a match score for each viewing subscriber that is a percentage of identified characteristics of the viewing subscriber receiving the media content from one of the one or more available channels at one of the one or more viewing times that match corresponding characteristics of a user of the computing device;
determine an order of one or more available channels to be listed in an electronic programming guide based at least in part on a number of subscribers receiving media content respectively from each of the one or more available channels at at least one of the one or more viewing times having a match score above a predetermined threshold;
and
display the electronic programming guide, including the one or more available channels in the determined order.

11. (canceled)

12. The system of claim 10, wherein the subscriber data stored in the popular channel database includes subscriber data collected at a plurality of viewing times.

13. The system of claim 12, wherein computing device is further programmed to determine an average number of subscribers viewing respectively each of the one or more available channels over a plurality of viewing times having a match score above the predetermined threshold; and
determine the order of channels listed in an electronic programming guide based at least in part on the determined average number of subscribers viewing respectively each of the one or more available channels.

14. (canceled)

15. A method comprising:
receiving, by a computing device, a popular channel database from a remote server, the popular channel database including data indicating subscribers viewing respectively each of one or more available channels of programming at one or more viewing times;
storing the popular channel database in a memory of the computing device;
receiving a subscriber demographic database indicating a plurality of demographic characteristics of each subscriber;
for each of the one or more channels at the one or more viewing times, identifying one or more demographic characteristics for each of a plurality of viewing subscribers;
determining a match score for each viewing subscriber that is a percentage of identified characteristics of the viewing subscriber receiving the media content from one of the one or more available channels at one of the one or more viewing times that match corresponding characteristics of a user of the computing device;
determining an order of channels to be displayed in an electronic programming guide based at least in part on a number of subscribers receiving media content respectively from each of the one or more available channels at at least one of the one or more viewing times having a match score above a predetermined threshold; and
displaying the electronic programming guide, including the one or more available channels in the determined order.

16. The method of claim 15, further comprising:
recognizing a start time when a user activates the computing device; and
downloading the popular channel database from the remote server upon recognizing the start time.

17. The method of claim 16, wherein determining the order of channels to be displayed is based on data representing a number of subscribers receiving respectively each of the one or more channels at a viewing time having a match score above the predetermined threshold within a predetermined period of the start time.

18. The method of claim 15, further comprising:
determining an average number of subscribers viewing respectively each of the one or more available channels over a plurality of viewing times having a match score above the predetermined threshold; and
determining the order of channels listed in the electronic programming guide based on the determined average number of subscribers for each of the respective channels.

19. The method of claim 15, further comprising periodically downloading the popular channel database.

20. (canceled)
